(19) United States
(12) Patent Application Publication
(10) Pub. No.: US 2004/0042031 A1
(43) Pub. Date: Mar. 4, 2004

(54) Method to improve fax transmission quality over packet based networks using V.21 full duplex for echo handling

(76) Inventors: Mehrdad Abrishami, Gaithersburg, MD (US); Jianwei Bei, Rockville, MD (US)

Correspondence Address: LSI LOGIC CORPORATION, 1621 BARBER LANE, MS: D-106 LEGAL, MILPITAS, CA, 95035, US

(21) Appl. No.: 10/229,607

(22) Filed: Aug. 28, 2002

(51) Int. Cl. H04N 1/32; G06F 13/00; G06F 15/00

(52) U.S. Cl. 358/1.15; 358/434

(57) ABSTRACT

A method and apparatus for improving fax transmission success rate when transmitting over a packet-based network. The method and apparatus is based on the detection and demodulation of the V.21 echo during the transmission of the Binary Coded Signal (BCS), and anticipates the peer response and discriminates between the possible responses and the generating machine's echo transmission. The gateway demodulates any echo signal received while the gateway is transmitting a Binary Coded Signal (BCS), and waits until the end of the echo signal before accepting a response.

### BACKGROUND

The present invention generally relates to fax transmissions over packet based networks, and more specifically relates to a method and apparatus for improving fax transmission success rate when transmitting over a packet-based network. The method and apparatus is based on the detection and demodulation of the V.21 echo during the transmission of the Binary Coded Signal (BCS), and anticipates the peer response and discriminates between the possible responses and the generating machine's echo transmission.

The present invention relates to a method and apparatus for maintaining a fax transmission over a communications path that includes a narrowband or a packet network. An example of such a packet network is an IP (Internet Protocol) network. The T.38 fax relay protocol is used when transmitting a facsimile over an IP network. In particular, the present invention relates to a method and apparatus for maintaining a fax transmission even though there may exist echo during the transmission of the BCS signal by the generating Group 3 fax terminal. When echo of the transmitting signal is mistakenly relayed as T.38 packets to the peer, it may result in BCS packet collisions and/or the violation of the T.30 protocol and result in the failure of the fax relay transmission.

In its T.30 and T.4 standards, the Telecommunications Standardization Section of the ITU (ITU-T) has defined procedures for facsimile transmission of documents in a public switched telephone network (PSTN). The T.30 and T.4 standards define a Group 3 facsimile service, also known as Group 3 FAX and G3 FAX. The recommendation is for a “Group 3 facsimile apparatus.” A Group 3 facsimile apparatus includes any one of (1) a facsimile machine, (2) a computer with a facsimile modem and corresponding software, and (3) other similar products. As referred to herein, the term “facsimile machine” or “fax machine” applies to any Group 3 facsimile apparatus.

The T.30 standard was written for a facsimile provided over a wired telephone network, a PSTN, or a digital encoding of the analog signal (e.g., using PCM). However, in a bandwidth-limited digital network or a packet network such as the Internet, other techniques are used to send a facsimile in real-time.

One method of supporting Group 3 FAX over bandwidth-limited digital network or a packet network, such as Internet, uses a facsimile relay system to (1) demodulate the analog facsimile signal, (2) transmit the digital data using the digital network or packet network, and (3) remodulate the signal at the other relay station to provide an analog signal. In such a system, in addition to demodulating and remodulating the facsimile signal, the T.30-based relay protocol is implemented in the relay gateways. ITU-T T.38 is one such T.30-based relay protocol specified for the IP network. T.38 specifies the messages and data exchanged between facsimile gateways connected via an IP network.

When a gateway is transmitting BCS toward a G3FE, there may exist sufficient echo, such that the same transmitting gateway may interpret the echo of its own transmitted signal as the start of the response from the G3FE. When echo of the transmitting signal is mistakenly interpreted as the start of the response from the G3FE, the gateway will send a T.38 packet indicator to the peer. The peer gateway will then start transmitting flags to the connected G3FE. After the original gateway detects the drop in the received echo signal, it relays the information to the peer, which then stops transmitting the erroneous V.21 modulated data. This causes the G3FE to perform a retransmission of the BCS signal. Following the end of the echo signal, the actual BCS arrives and is relayed to the peer. This event may arrive at the peer after the retransmission of the BCS by the G3FE has already started. This collision of events and race condition may result in fax transmission failure.

### OBJECTS AND SUMMARY

A general object of an embodiment of the present invention is to provide a method and apparatus to improve fax quality when transmitting fax over packet based network.

Another object of an embodiment of the present invention is to provide a method and apparatus for detecting and demodulating a V.21 echo during the transmission of the Binary Coded Signal (BCS).

Still another object of an embodiment of the present invention is to provide a method and apparatus for maintaining a fax transmission even though there may exist echo during the transmission of the Binary Coded Signal (BCS) by the generating Group 3 fax terminal.

Briefly, and in accordance with at least one of the foregoing objects, an embodiment of the present invention provides a method and apparatus for improving facsimile transmission success rate when transmitting a facsimile over a packet based network. The network includes receiving facsimile equipment, sending facsimile equipment, and at least one gateway between the receiving facsimile equipment and sending facsimile equipment. The sending facsimile equipment sends data to the receiving facsimile equipment through the gateways. The gateway demodulates any echo signal received while the gateway is transmitting a V.21 Binary Coded Signal (BCS), and the gateway waits until the end of the echo signal before accepting a response.

### BRIEF DESCRIPTION OF THE DRAWINGS

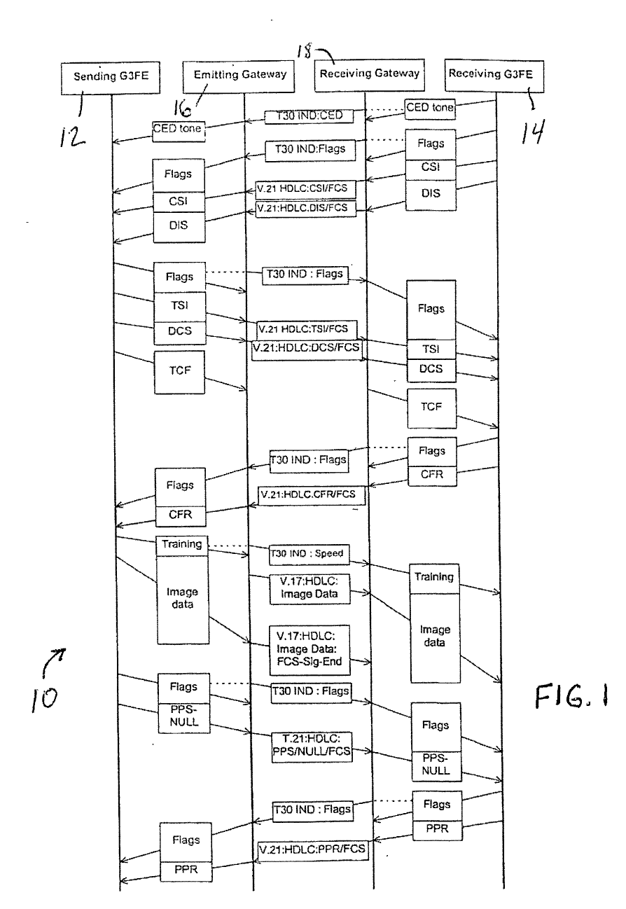

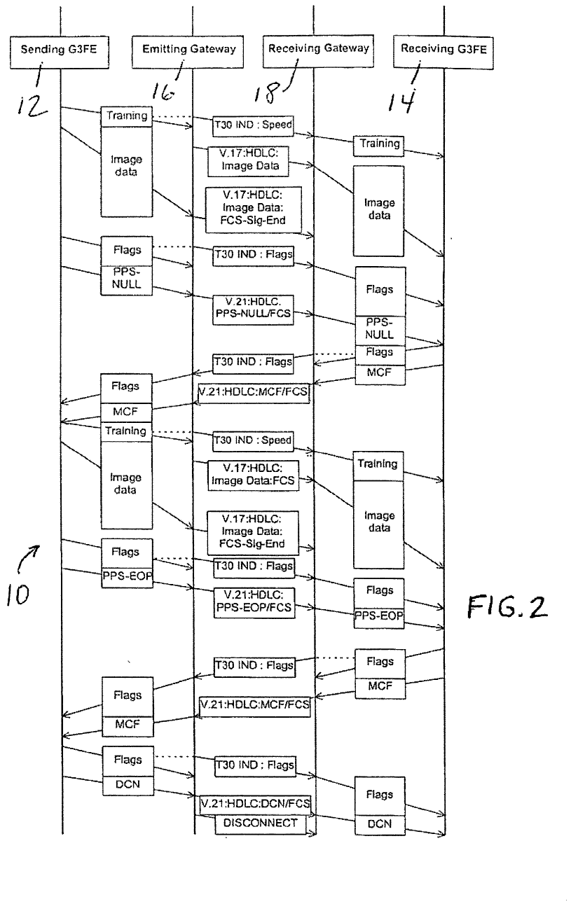

The organization and manner of the structure and operation of the invention, together with further objects and advantages thereof, may best be understood by reference to the following description, taken in connection with the accompanying drawings, wherein FIGS. 1 and 2 show a packet based network, wherein two Group 3 facsimile devices are communicating through gateways.

### DESCRIPTION

While the invention may be susceptible to embodiment in different forms, there are shown in the drawings, and herein will be described in detail, specific embodiments with the understanding that the present disclosure is to be considered an exemplification of the principles of the invention, and is not intended to limit the invention to that as illustrated and described herein.

FIGS. 1 and 2 illustrate messages being transmitted in a packet based network 10 between two G3FE's, i.e. between a sending G3FE 12 or sending facsimile equipment and a receiving G3FE 14 or receiving facsimile equipment. The messages are communicated through gateways, and FIGS. 1 and 2 illustrate an emitting gateway 16 and a receiving gateway 18.

A method in accordance with the present invention provides that the sending facsimile equipment 12 sends data to the emitting gateway 16, and the emitting gateway 16 transmits the data to the receiving gateway 18 (and to the receiving facsimile equipment 14). The gateways 16 and 18 include a modem, and are configured to demodulate any V.21 echo signal received while transmitting the V.21 Binary Coded Signal (BCS). The gateways 16 and 18 are configured to wait until an end of the echo signal received before accepting a response.

When either gateway 16 or 18 demodulates the received V.21 echo signal while, at the same time, it is transmitting, it can correlate the received, demodulated V.21 echo signal with its own transmitted data and anticipate the end of the echo signal. During the transmission of the Binary Coded Signal (BCS) V.21 message within the facsimile relay protocol, the V.21 modem is initialized in channel 2 receive mode (for full-duplex operation) to detect any echo of the transmitted signal. Knowing that the T.30 protocol is half-duplex, if there is actual demodulated valid bits (Flags or otherwise), the received signal has to be echo of the transmitted V.21 signal. If the echo is present, then the facsimile relay protocol waits for the end of the reception of the echo and loss of lock (i.e., invalid bits, or zero) before re-initializing the V.21 modem in receive mode to accept the BCS response. Since only after the end of the echo has been detected, then the gateway 16 or 18 enables itself to detect the start of the V.21 response, the echo signal is never mistakenly sent.

The T.38 defines the procedures to allow G3 facsimile transmission between terminals where, in addition to the PSTN, a portion of the transmission path used between terminals includes an IP network, e.g. the Internet, T.38 specifies the messages and data exchanged between facsimile gateways connected via an IP network. Using a V.21 modem in full-duplex mode, a facsimile relay gateway can distinguish between echo and an actual BCS response, thereby increasing the rate of success for fax relay in a network.

The present invention may be used in, for example, the following applications/environment: voice over IP applications, compressed networks over E1/T1, satellite communications—VSATs, voice over cable modems, and other packet based networks.

While embodiments of the present invention are shown and described, it is envisioned that those skilled in the art may devise various modifications of the present invention without departing from the spirit and scope of the appended claims.

What is claimed is:

1. A method for improving facsimile transmission success rate when transmitting a facsimile over a packet based network, wherein the network includes receiving facsimile equipment, sending facsimile equipment, and at least one gateway between the receiving facsimile equipment and sending facsimile equipment, said method comprising:
having the sending facsimile equipment send data to the gateway;
having the gateway transmit the data to the receiving facsimile equipment;
having the gateway demodulate any echo signal received while the gateway is transmitting a Binary Coded Signal (BCS); and
having the gateway wait until an end of the echo signal received before accepting a response.

2. A method as recited in claim 1, wherein the echo signal is a V.21 echo signal.

3. A method as recited in claim 1, wherein the gateway includes a modem, and said method further comprises initializing the modem in channel two receive mode to facilitate full-duplex operation while the gateway is transmitting the Binary Coded Signal (BCS).

4. A method as recited in claim 3, further comprising having the modem detect any echo signal received by the gateway.

5. A method as recited in claim 4, further comprising waiting for the echo signal to end, and re-initialing the modem in receive mode to accept the response.

6. A gateway configured to improve facsimile transmission success rate when transmitting a facsimile over a packet based network, wherein the network includes receiving facsimile equipment, sending facsimile equipment, and the gateway is configured to be disposed between the receiving facsimile equipment and sending facsimile equipment, said gateway configured to demodulate any echo signal received while the gateway is transmitting a Binary Coded Signal (BCS), and said gateway configured to wait until an end of the echo signal received before accepting a response.

7. A gateway as recited in claim 6, wherein the echo signal is a V.21 echo signal.

8. A gateway as recited in claim 6, wherein the gateway includes a modem, and the modem is configured to initialize in channel two receive mode to facilitate full-duplex operation while the gateway is transmitting the Binary Coded Signal (BCS).

9. A gateway as recited in claim 8, wherein the modem is configured to detect any echo signal received.

10. A gateway as recited in claim 9, wherein the modem is configured to wait for the echo signal to end, and then re-initialize in receive mode to accept the response.

11. A packet based network configured to improve facsimile transmission success rate when transmitting a facsimile, said network comprising receiving facsimile equipment, sending facsimile equipment, and a gateway between the receiving facsimile equipment and sending facsimile equipment, said gateway configured to demodulate any echo signal received while the gateway is transmitting a Binary Coded Signal (BCS), and said gateway configured to wait until an end of the echo signal received before accepting a response.

12. A packet based network as recited in claim 11, wherein the echo signal is a V.21 echo signal.

13. A packet based network as recited in claim 11, wherein the gateway includes a modem, and the modem is configured to initialize in channel two receive mode to facilitate full-duplex operation while the gateway is transmitting the Binary Coded Signal (BCS).

14. A packet based network as recited in claim 13, wherein the modem is configured to detect any echo signal received.
